(19) United States
(12) Patent Application Publication
(10) Pub. No.: US 2026/0264464 A1
(43) Pub. Date: Sep. 10, 2026

(54) BOLT-ASSEMBLED SPLIT-TYPE HITCH BALL

(71) Applicant: Qingdao Kemei Trailer CO.,LTD, QINGDAO (CN)

(72) Inventors: GUOHAO GONG, Qingdao (CN); HAOJUN GONG, Qingdao (CN); DESHENG GONG, Qingdao (CN)

(21) Appl. No.: 19/661,827

(22) Filed: Apr. 29, 2026

(51) Int. Cl. B60D 1/06; B60D 1/07

(52) U.S. Cl. CPC B60D 1/06; B60D 1/07

(57) ABSTRACT

A bolt-assembled split-type hitch ball includes a bolt, where the bolt passes through a ball and a shoulder, the shoulder abuts against a lower surface of the ball, a second anti-rotation groove and a first anti-rotation groove are formed in the shoulder and the ball, respectively, and an anti-rotation key is jointly mounted in cavities of the second anti-rotation groove and the first anti-rotation groove; a spring washer abuts against a lower surface of the shoulder, the spring washer is sleeved on an outer side of the bolt, and a nut abuts against a lower surface of the spring washer; and the nut is threadedly connected to the bolt, and a retaining pin is disposed below the nut. A user only needs to prepare spare balls of different sizes to adapt to various trailer couplers, thereby avoiding the extra cost of purchasing a plurality of hitch ball assemblies.

### TECHNICAL FIELD

The present disclosure belongs to the technical field of hitch balls, and particularly relates to a bolt-assembled split-type hitch ball.

### BACKGROUND

A hitch ball is a key component mounted on a rear of a towing vehicle (such as an off-road vehicle, a pickup truck, or a tractor) for connecting a towed vehicle, such as a trailer, a recreational vehicle, or a boat trailer. In scenarios such as outdoor transportation, camping, and boat transportation, the hitch ball is required to withstand relatively large tractive forces and impact loads, and its structural strength and connection reliability directly affect towing safety.

Currently, common hitch balls on the market are mainly integral hitch balls. An integral hitch ball has a ball and a shoulder formed as one piece, and exhibits the following disadvantages: first, the ball has a fixed size and cannot be replaced with a ball of a different size to adapt to different trailer coupler specifications, and a user needs to purchase a plurality of spare hitch balls of different specifications, which is inconvenient to use and costly; and second, once the ball is worn or damaged, the entire hitch ball assembly needs to be replaced, resulting in high maintenance costs.

### SUMMARY

To solve the above problems raised in the background, the present disclosure provides a bolt-assembled split-type hitch ball, which has the advantages of a replaceable ball and low maintenance costs.

To achieve the above objective, the present disclosure provides the following technical solution: A bolt-assembled split-type hitch ball includes a bolt, where the bolt passes through a ball and a shoulder, the shoulder abuts against a lower surface of the ball, a second anti-rotation groove and a first anti-rotation groove are formed in the shoulder and the ball, respectively, and an anti-rotation key is jointly mounted in cavities of the second anti-rotation groove and the first anti-rotation groove; a spring washer abuts against a lower surface of the shoulder, the spring washer is sleeved on an outer side of the bolt, and a nut abuts against a lower surface of the spring washer; and the nut is threadedly connected to the bolt, a retaining pin is disposed below the nut, and the retaining pin is mounted at an end of the bolt.

As a preferred embodiment of the bolt-assembled split-type hitch ball according to the present disclosure, flat surfaces are formed on both sides of an outer wall of the shoulder.

As a preferred embodiment of the bolt-assembled split-type hitch ball according to the present disclosure, a circular groove is formed in each of the ball and the shoulder, and the first anti-rotation groove and the second anti-rotation groove are formed respectively in cavities of the corresponding circular grooves.

As a preferred embodiment of the bolt-assembled split-type hitch ball according to the present disclosure, an inner diameter of the circular groove matches an outer diameter of the bolt.

As a preferred embodiment of the bolt-assembled split-type hitch ball according to the present disclosure, an annular groove is further formed in an inner wall of the circular groove of the ball, and a head of the bolt is recessed in a cavity of the annular groove.

As a preferred embodiment of the bolt-assembled split-type hitch ball according to the present disclosure, an inner diameter of the annular groove is larger than the inner diameter of the circular groove, an outer diameter of the head of the bolt is also larger than the inner diameter of the circular groove, and the outer diameter of the head of the bolt matches the inner diameter of the annular groove.

As a preferred embodiment of the bolt-assembled split-type hitch ball according to the present disclosure, a flat groove is formed at an end of the bolt, a pin hole is formed in an outer wall of the flat groove, and the retaining pin is mounted in the pin hole.

Compared with the prior art, the present disclosure has the following beneficial effects:
1. Through the split design of the ball and the shoulder, a user only needs to prepare spare balls of different sizes to adapt to various trailer couplers, thereby avoiding the extra cost of purchasing a plurality of hitch ball assemblies; and when the ball is worn, only the ball needs to be replaced separately, which significantly reduces maintenance costs.
2. The cooperation between the anti-rotation key and the anti-rotation grooves fundamentally eliminates the possibility of ball rotation. Even under heavy-load towing or sharp turning conditions, the ball can maintain a stable attitude, thereby improving the reliability and safety of trailer connection.
3. The present disclosure employs a four-fold protection design consisting of the "anti-rotation key for preventing rotation + spring washer for resisting loosening + nut for secure locking + retaining pin for preventing detachment". The anti-rotation key cooperates with the anti-rotation grooves to prevent rotation between the ball and the shoulder, the spring washer absorbs vibration energy, the nut provides the main locking force, and the retaining pin acts as a final safeguard to effectively prevent the risk of complete nut detachment under extreme operating conditions that may cause separation of the ball and the shoulder, thereby significantly enhancing the safety redundancy and reliability of the hitch ball during long-term use.

### BRIEF DESCRIPTION OF THE DRAWINGS

The drawings are intended to provide a further understanding of the present disclosure and constitute a part of the specification. Together with the embodiments of the present disclosure, the drawings serve to explain the present disclosure and do not constitute limitations to the present disclosure. In the drawings:

FIG. 1 is a schematic external structural view of Embodiment 1 of the present disclosure.

FIG. 2 is a schematic front structural view of Embodiment 1 of the present disclosure.

FIG. 3 is an exploded external structural view of Embodiment 1 of the present disclosure.

FIG. 4 is a schematic external structural view of Embodiment 2 of the present disclosure.

FIG. 5 is a schematic front structural view of Embodiment 2 of the present disclosure.

FIG. 6 is an exploded external structural view of Embodiment 2 of the present disclosure.

FIG. 7 is a schematic external structural view of Embodiment 3 of the present disclosure.

FIG. 8 is a schematic front structural view of Embodiment 3 of the present disclosure.

FIG. 9 is an exploded external structural view of Embodiment 3 of the present disclosure.

Reference numerals in the figures: 1-bolt; 2-ball; 3-shoulder; 4-spring washer; 5-nut; 6-retaining pin; 7-anti-rotation key; 8-first anti-rotation groove; 9-second anti-rotation groove; and 10-flat surface.

### DETAILED DESCRIPTIONS OF THE EMBODIMENTS

The technical solutions in embodiments of the present disclosure will be clearly and completely described below in combination with the drawings in the embodiments of the present disclosure. It is obvious that the described embodiments are only a part of, rather than all of, the embodiments of the present disclosure. Based on the embodiments in the present disclosure, all other embodiments obtained by those of ordinary skill in the art without making creative efforts will fall within the protection scope of the present disclosure.

### Embodiment 1:

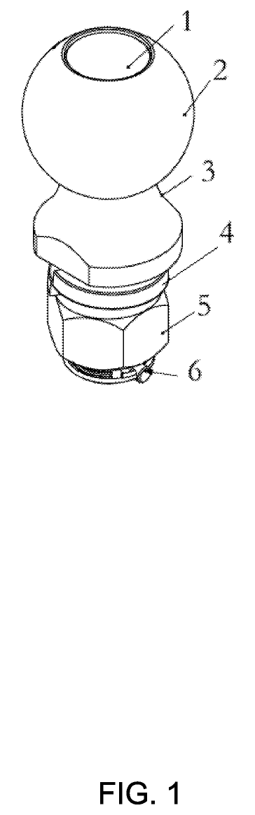

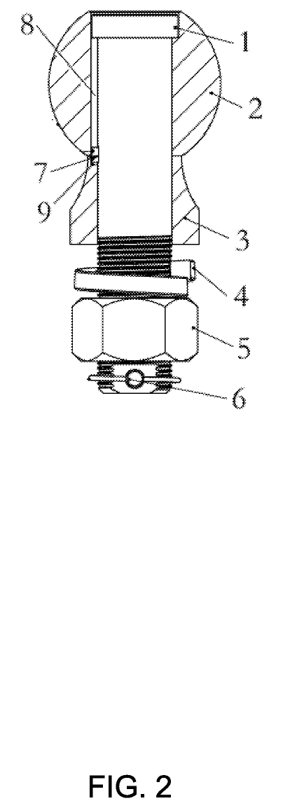

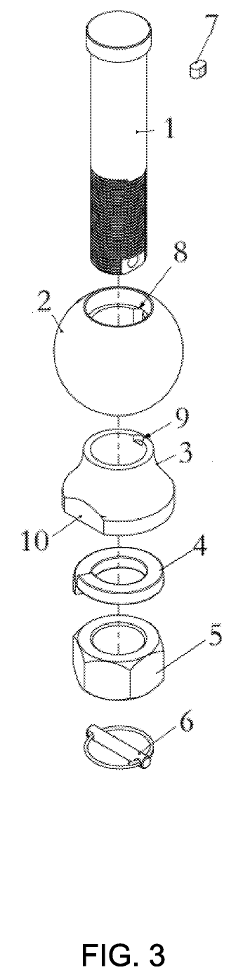

As shown in FIG. 1, FIG. 2, and FIG. 3, a bolt-assembled split-type hitch ball includes a bolt 1, where the bolt 1 passes through a ball 2 and a shoulder 3, the shoulder 3 abuts against a lower surface of the ball 2, a second anti-rotation groove 9 and a first anti-rotation groove 8 are formed in the shoulder 3 and the ball 2, respectively, and an anti-rotation key 7 is jointly mounted in cavities of the second anti-rotation groove 9 and the first anti-rotation groove 8; a spring washer 4 abuts against a lower surface of the shoulder 3, the spring washer 4 is sleeved on an outer side of the bolt 1, and a nut 5 abuts against a lower surface of the spring washer 4; and the nut 5 is threadedly connected to the bolt 1, a retaining pin 6 is disposed below the nut 5, and the retaining pin 6 is mounted at an end of the bolt 1.

In this embodiment, specifically, during use, first, the ball 2 and the shoulder 3 are sequentially sleeved on the bolt 1, such that the shoulder 3 abuts against the lower surface of the ball 2, and the anti-rotation key 7 is inserted into the cavities of the first anti-rotation groove 8 and the second anti-rotation groove 9 to lock the ball 2 and the shoulder 3 together; then, the spring washer 4 is sleeved on the outer side of the bolt 1 and abuts against the lower surface of the shoulder 3; thereafter, the nut 5 is threadedly connected to the bolt 1 and tightened, causing the spring washer 4 to elastically deform and provide a continuous axial preload; and finally, the retaining pin 6 is mounted in the pin hole at the end of the bolt 1 to prevent the nut 5 from detaching from the end of the bolt 1.

Specifically, only a part of the bolt 1 is provided with threads for mounting the nut 5, and a plurality of balls 2 of different sizes may be prepared in advance to adapt to different trailer couplers.

In an optional embodiment, flat surfaces 10 are formed on both sides of an outer wall of the shoulder 3.

In this embodiment, specifically, by forming the flat surfaces 10, a tightening fit is formed between the shoulder 3 and a mounting seat of a towing vehicle.

In an optional embodiment, a circular groove is formed in each of the ball 2 and the shoulder 3, and the first anti-rotation groove 8 and the second anti-rotation groove 9 are formed respectively in cavities of the corresponding circular grooves.

In this embodiment, specifically, by forming the circular grooves, a passage is provided for the bolt 1 to pass through.

In an optional embodiment, an inner diameter of the circular groove matches an outer diameter of the bolt 1.

In this embodiment, specifically, through the equal-diameter fit design between the circular grooves and the bolt 1, the bolt 1, after passing through the ball 2 and the shoulder 3, can fit tightly, thereby reducing gaps, avoiding wobbling of the ball 2 and the shoulder 3 on the bolt 1, and improving the stability and reliability of the connection.

In an optional embodiment, an annular groove is further formed in an inner wall of the circular groove of the ball 2, and a head of the bolt 1 is recessed in a cavity of the annular groove.

In this embodiment, specifically, by forming the annular groove, the head of the bolt 1 can be completely recessed inside the ball 2 without protruding from the surface of the ball 2. This concealed design is both aesthetically pleasing and prevents the head of the bolt 1 from interfering with other components.

In an optional embodiment, an inner diameter of the annular groove is larger than the inner diameter of the circular groove, an outer diameter of the head of the bolt 1 is also larger than the inner diameter of the circular groove, and the outer diameter of the head of the bolt 1 matches the inner diameter of the annular groove.

In this embodiment, specifically, through the design in which the inner diameter of the annular groove is larger than the inner diameter of the circular groove, the head of the bolt 1 can be recessed in the annular groove and be limited, thereby preventing the bolt 1 from detaching from the ball 2. The equal-diameter fit between the outer diameter of the head of the bolt 1 and the inner diameter of the annular groove ensures that the head of the bolt 1 fits tightly with the annular groove, thereby reducing gaps and improving the stability of the connection.

In an optional embodiment, a flat groove is formed at an end of the bolt 1, a pin hole is formed in an outer wall of the flat groove, and the retaining pin 6 is mounted in the pin hole.

In this embodiment, specifically, by forming the flat groove and the pin hole, a mounting position is provided for the retaining pin 6.

### Embodiment 2

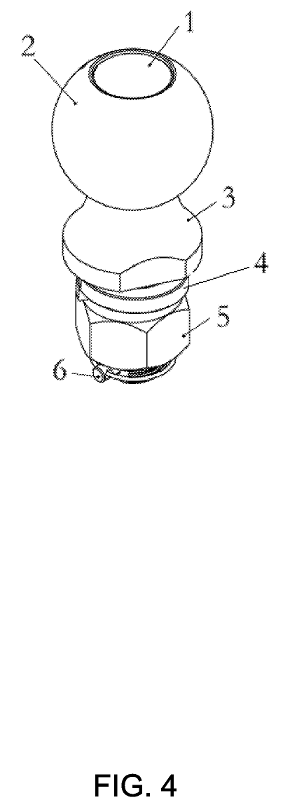

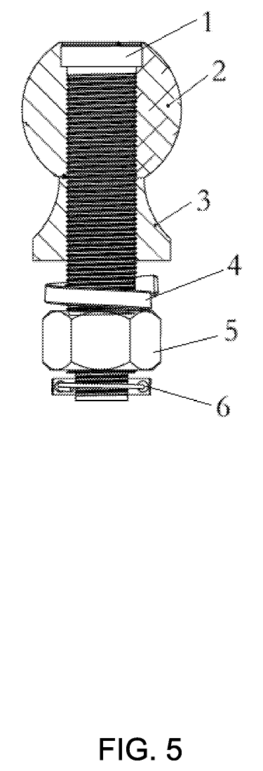

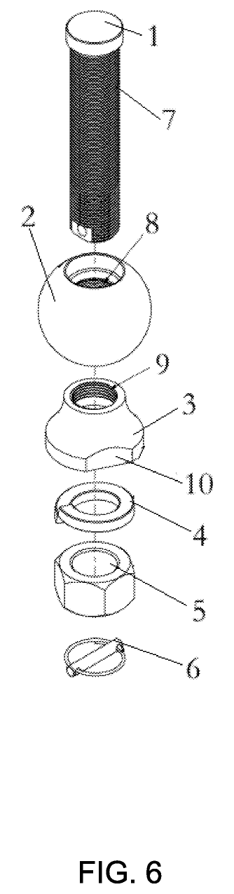

With reference to FIG. 4, FIG. 5, and FIG. 6, improvements are made to the bolt-assembled split-type hitch ball of Embodiment 1.

In this embodiment, a shank of the bolt 1 is provided with an external thread, and inner walls of the circular groove of the ball 2 and the circular groove of the shoulder 3 are each provided with an internal thread for threadedly connecting to the bolt 1, where the external thread on the bolt 1 can serve as the anti-rotation key 7, and the internal thread on the ball 2 and the internal thread on the shoulder 3 are regarded respectively as the first anti-rotation groove 8 and the second anti-rotation groove 9, and configured to prevent the shoulder 3 and the ball 2 from rotating.

### EMBODIMENT 3

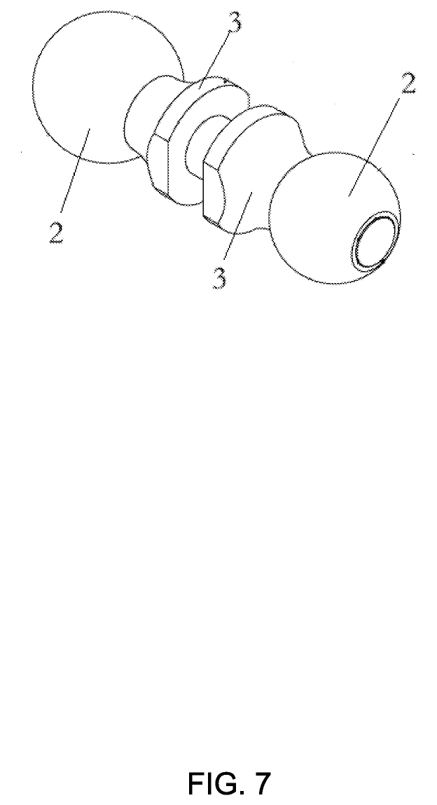

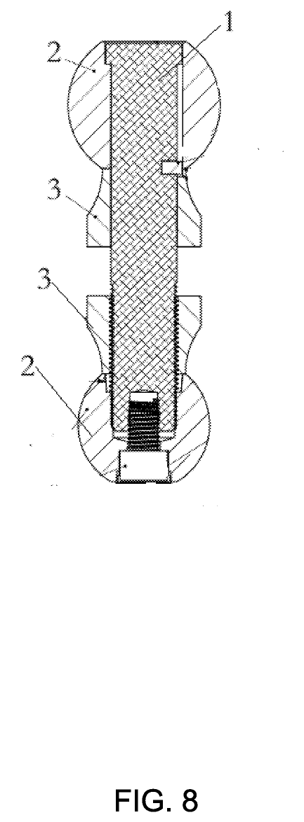

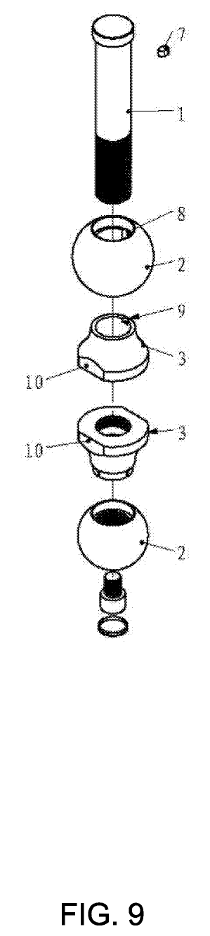

With reference to FIG. 7, FIG. 8, and FIG. 9, improvements are made to the bolt-assembled split-type hitch balls of Embodiment 1 and Embodiment 2.

In this embodiment, Embodiment 1 and Embodiment 2 are combined to form a double-ball hitch ball structure, and the specific operations include the following steps:

S1, first, the bolt 1, the ball 2, the shoulder 3, and the anti-rotation key 7 in Embodiment 1 are selected, and the ball 2 and the shoulder 3 are sequentially inserted onto the bolt 1, and cooperate with the anti-rotation key 7 to achieve an anti-rotation effect;

S2, then, the ball 2 and the shoulder 3 in Embodiment 2 are selected, because the ball 2 and the shoulder 3 in Embodiment 2 have internal threads disposed in the inner circular grooves thereof, the shoulder 3 and the ball 2 can be sequentially threadedly connected to the outer side of the bolt 1, and the threaded connection is used for mounting, thereby achieving the purpose of mounting two balls 2 on a single bolt 1; and

S3, finally, the retaining pin 6 is used to prevent loosening of the threaded connection, thereby achieving complete assembly of the hitch ball in a double-ball configuration.

Finally, it should be noted that the above descriptions are only preferred embodiments of the present disclosure and are not intended to limit the present disclosure. Although the present disclosure has been described in detail with reference to the above embodiments, for those skilled in the art, they may still modify the technical solutions described in the above embodiments or make equivalent substitutions for some of the technical features thereof. Any modification, equivalent substitution or improvement within the spirit and principle of the present disclosure should fall within the protection scope of the present disclosure.

What is claimed is:

1. A bolt-assembled split-type hitch ball, comprising a bolt, wherein the bolt passes through a ball and a shoulder, the shoulder abuts against a lower surface of the ball, a second anti-rotation groove and a first anti-rotation groove are formed in the shoulder and the ball, respectively, and an anti-rotation key is jointly mounted in cavities of the second anti-rotation groove and the first anti-rotation groove; a spring washer abuts against a lower surface of the shoulder, the spring washer is sleeved on an outer side of the bolt, and a nut abuts against a lower surface of the spring washer; and the nut is threadedly connected to the bolt, a retaining pin is disposed below the nut, and the retaining pin is mounted at an end of the bolt.

2. The bolt-assembled split-type hitch ball according to claim 1, wherein flat surfaces are formed on both sides of an outer wall of the shoulder.

3. The bolt-assembled split-type hitch ball according to claim 2, wherein a circular groove is formed in each of the ball and the shoulder, and the first anti-rotation groove and the second anti-rotation groove are formed respectively in cavities of the corresponding circular grooves.

4. The bolt-assembled split-type hitch ball according to claim 3, wherein an inner diameter of the circular groove matches an outer diameter of the bolt.

5. The bolt-assembled split-type hitch ball according to claim 4, wherein an annular groove is further formed in an inner wall of the circular groove of the ball, and a head of the bolt is recessed in a cavity of the annular groove.

6. The bolt-assembled split-type hitch ball according to claim 5, wherein an inner diameter of the annular groove is larger than the inner diameter of the circular groove, an outer diameter of the head of the bolt is also larger than the inner diameter of the circular groove, and the outer diameter of the head of the bolt matches the inner diameter of the annular groove.

7. The bolt-assembled split-type hitch ball according to claim 1, wherein a flat groove is formed at an end of the bolt, a pin hole is formed in an outer wall of the flat groove, and the retaining pin is mounted in the pin hole.
